(19) United States
(12) Patent Application Publication
(10) Pub. No.: US 2004/0023044 A1
(43) Pub. Date: Feb. 5, 2004

(54) Method of manufacturing surface ornament plate, product for use in such method

(76) Inventor: Kousuke Ban, Yokohama (JP)

Correspondence Address: KOUSUKE BAN, 3-48-10, HARAJUKU, TOTUKA-KU, YOKOHAMA-CITY, KANAGAWA, 2450063, JP

(21) Appl. No.: 10/207,215

(22) Filed: Jul. 30, 2002

(51) Int. Cl. B32B 3/00

(52) U.S. Cl. 428/458; 428/195.1

(57) ABSTRACT

The product of a surface ornament plate having excellence in durability and in ornamentation and the method of manufacturing it are provided. The surface ornament plate is stuck with a printed transparent or translucent film on the surface of a metal plate with glossy plating. The manufacturing method of the surface ornament plate consists of: the process in which certain chosen pictures are printed on the film side of a water transfer paper composed of transparent or translucent film on a backing paper with water-soluble glue, the process in which the film is separated from the backing paper of the water transfer paper in a liquid, the process in which the film separated from the backing paper is stuck to the glossy plating surface of the metal plate and is fixed to it.

### BACKGROUND OF THE INVENTION

This invention relates to the product of a surface ornament plate which is suitable for a decorative bookmark or tag and the process of producing them.

Until now bookmarks and tags have usually been made of paper or resin sheets, on the surface of which may be printed certain chosen pictures in order to enhance their decorative beauty and attractiveness.

As to such a bookmark made of paper or resin, it is necessary to produce adequate thickness in order to keep its durability. But such thickness is undesirable, because it will makes the book swell out where it is placed and will damage the book itself. Additionally, it is very difficult to produce metallic printings on the surface of a bookmark which is made of paper or resin at a low-price and in small quantity. Moreover, even if it were possible to print certain chosen pictures on the surface of bookmark made of paper or resin, it would be difficult to maintain the product's durability and could be easily damaged (both the printed certain chosen pictures and the paper or resin sheet itself) due to the fact that paper or resin sheet are too bendable and tear too easily.

Accordingly, it is an objective of the present invention to provide a surface ornament plate which is extremely durable as a bookmark while at the same time provides excellence in its ornamental nature and its method of manufacturing.

### BRIEF DESCRIPTION OF THE DRAWINGS

The above and other objects of the invention will be seen by reference to the description given in connection with the accompanying drawings, in which:

FIG. 1 is an example of a bookmark to which is applied an invention of a surface ornament plate. (a) is a partial sectional plan of the surface ornament plate. And (b) is an expansion of the partial sectional diagram of the surface ornament plate shown in (a).

FIG. 2 shows one case of the operation of the manufacturing method of the surface ornament plate shown in FIG. 1. Shown in (a) is the manufacturing process of a manuscript. Shown in (b) is a process in which a picture is printed on the film of water transfer paper. Shown in (c) is a process in which the film of the water transfer paper is separated from the cut surroundings of a picture. Shown in (d) is the process in which the film separated from the backing paper is stuck onto the plating surface of the metal plate having glossy plating. Shown in (e) is a process in which the film is dried. Shown in (f) is the low-temperature contact-printing process of sticking the film on the plating surface of a metal plate.

FIG. 3 is a part of fractured perspective diagram of the water transfer paper used for manufacture of a surface ornament plate.

FIG. 4 shows other cases of the operation of the surface ornament plate by this invention. Shown in (a) is a part of a fractured perspective diagram of a surface ornament plate. Shown in (b) is the expanded sectional diagram of the surface ornament plate shown in (a).

FIG. 5 shows one case of the operation of the manufacturing method of the surface ornament plate shown in FIG. 1. Shown in (a) is the process in which the film separated from the backing paper is stuck onto the plating surface of the metal plate. Shown in (b) is the process in which the film is dried. Shown in (c) is the low-temperature contact-printing process of sticking the film on the plating surface of a metal plate.

### EXPLANATION OF THE MARKS

10 Surface ornament plate

11 Metal plate

12 Gloss plating

20 Manuscript sheet

21 Original picture

22 Copy Machine

23 Water transfer paper

24 Backing Paper

25 Water-soluble glue

26 Film

27 Toner picture

28 Piece of paper

30 Container

31 Water

32 Rubber-spatula

33 Drier

34 Gas oven

35 Adhesion strengthening agent

### DESCRIPTION OF THE INVENTION

In order to solve the previously mentioned problems of traditional bookmarks, this invention provides the ornamental plate on which the low-temperature contact print of a transparent or translucent film can be printed with a picture on the glossy plating surface of a metal plate. On the surface ornament plate, the transparent or translucent film printed with the picture is stuck on the plating surface of the glossy metal plate. Therefore, the light reflected off the plating surface of the glossy metal plate penetrates the transparent or translucent film printed with the picture. In doing so, the printed picture portion can be made to achieve a metallic gloss peculiar to gloss plating, and the surface ornament plate rich in a high-class feeling can be provided.

Also, since a metal plate is used as its basic material, thickness can be reduced, while still excelling in durability and securing strength. For those reasons, it is the most suitable to apply this invention in particular to a bookmark.

Moreover, the manufacturing method of the surface ornament plate provides characteristics of: the process in which certain chosen pictures are printed on the film side of a water transfer paper composed of a transparent or translucent film on a backing paper with water-soluble glue, the process in which the film is separated from the backing paper of water transfer paper in a liquid, the process in which the film which is separated from the backing paper is stuck to the glossy plating surface of the metal plate and is fixed to it.

By the manufacturing method of the surface ornament plate having the above-mentioned composition, since a picture is printed on the film of water transfer paper, the film printed with the picture can be easily stuck on the plating surface of a metal plate. Moreover, since a metal plate is used as a base material, such film can be stuck in place firmly and permanently. Therefore, the film on which the picture is printed can be firmly stuck on the plating surface of a metal plate, and the surface ornament plate with excellent ornament nature and durability can be manufactured easily.

Through the manufacturing method of the aforementioned composition, preferably, in case a film is stuck on the plating surface of a metal plate, a film-adhesion strengthening agent is applied to the plating surface of a metal plate beforehand. In case a film is stuck on the plating surface of a metal plate according to such composition, a film-adhesion strengthening agent is beforehand applied to the plating surface of a metal plate, so the adhesive intensity of the film to the plating surface of a metal plate can be raised, and a surface ornament plate with higher durability will be provided.

Moreover, preferably, in case a film sticks to the plating surface of a metal plate, a film is heated by the temperature of 80 to 100 degrees C. as a temperature for baking. Due to such heating, a film can be firmly stuck on the plating surface of a metal plate, preventing discoloration, degradation, etc.

Furthermore, preferably, before a film is backed by the temperature of baking, the film is dried at a lower temperature. Due to such drying, it is possible to evaporate and to remove all liquid before the film is stuck on the plating surface of a metal plate. Thereby, when a film is stuck to the plating surface of a metal plate, air bubbles that are left behind between the film and the plating surface of a metal plate can be prevented, and the degree of flatness and smoothness of the surface of a film is improved.

Moreover, printing to a film performed by melting adhesion of a toner image is preferable. Due to such melting adhesion, a picture having excellence in water resistance can be printed on the film of water transfer paper at a low price using a commercial laser beam printer, a color copier, etc.

### DESCRIPTION OF THE PREFERRED EMBODIMENTS

Hereinafter, the desirable operation style of this invention is explained with reference to the attached drawings.

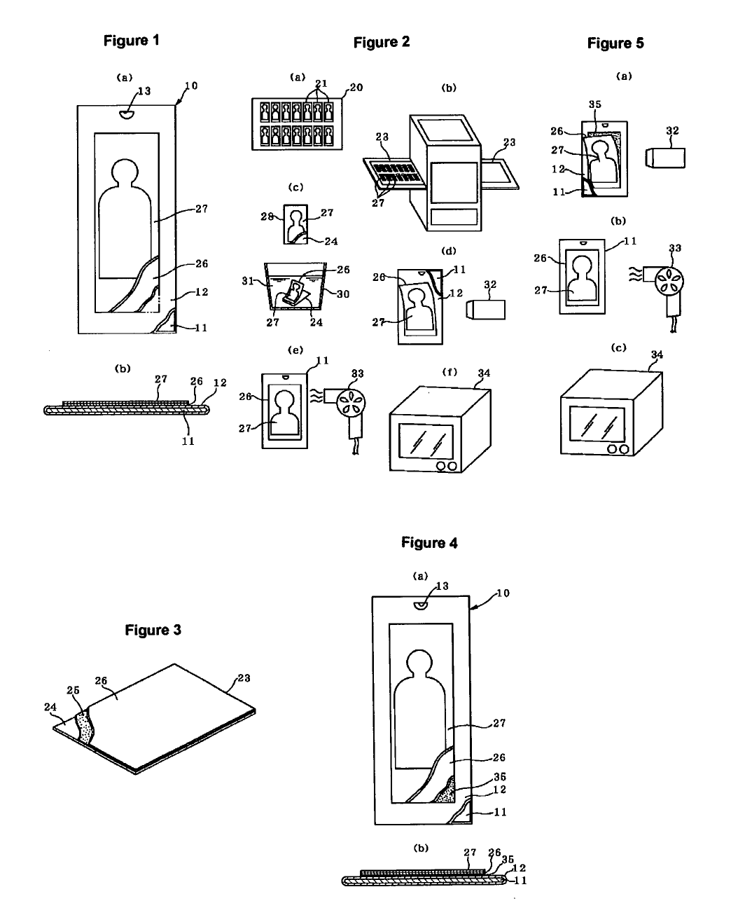

FIG. 1 shows one case of the operation applying this invention to a bookmark. Shown in (a) FIG. 1 is a part of fractured perspective diagram of a surface ornament plate. Shown in (b) is the expanded sectional diagram of the surface ornament plate shown in (a).

When this figure is referred to, the surface ornament plate (11) by use in this invention is equipped with the metal plate (11) which is cut down by certain chosen outside sizes. And gloss plating (12) is given to the surface of this metal plate (11). The metal plate (11) can be made from various metals, such as iron, copper, brass, aluminum, and stainless steel. For example, when stainless steel having moderate spring nature is applied to metal plate (11), it is the most suitable for a bookmark because it is difficult to bend or tear easily even if it were made very thin. Although it is enough if the gloss plating (12) is glossy, it is desirable to use precious-metal plating of gold, silver, platinum, etc for the gloss plating (12) because it gives richness and a high-class feeling. Although the gloss plating (12) can be plated in whole or part of a surface of the metal plate (11), it is important to give metal plating (12) at least to the film-attachment area which is mentioned later. A hole (13) is provided in the metal plate (11) to which a string is attached if needed (diagram omitted).

In the plating surface of the metal plate (11), the transparent or translucent film (26) printed with the certain chosen picture (27) is stuck on the surface. This film (26)—consisting of vinyl chloride resin, an acrylic resin, etc.—is separated from the backing paper of the water transfer paper, and is stuck on the plating surface of the metal plate (11) which is mentioned later. Although the picture (27) is not especially limited, the toner image having water resistance is provided in picture (27) here by using a color laser printer or a color laser copy machine.

In the surface ornament plate (10) of the above-mentioned composition, the transparent or translucent film (26) on which is printed certain chosen pictures (27) is stuck onto the plating surface of the metal plate (11) with gloss plating (12). So when the light reflected off the plating surface of a metal plate (11) penetrates the transparent or translucent film (26) printed with the picture (27), the picture (27) can be made to produce metallic gloss peculiar to gloss plating. Therefore, the surface ornament plate (10) rich in a high-class feeling can be provided. Thickness can also be reduced, while still excelling in durability and ensuring strength, since a metal plate (11) is used as the basic material. Especially when the surface ornament plate (10) is used as a bookmark, it can prevent a book from swelling out where it is placed because of the thinness of the surface ornament plate (10), or a bend-mark can be attached to a book.

Then, a desirable case of the operation of the manufacturing method of the surface ornament plate (10) having the above-mentioned composition is explained with reference to FIGS. 2 and 3.

FIG. 2 shows one case of the operation of the manufacturing method of the surface ornament plate shown in FIG. 1. (a) shows a manuscript manufacturing process; (b) shows a process in which a picture is printed on the film of water transfer paper; (c) shows a process in which the film of the water transfer paper is separated from the determined surroundings of a picture from base paper; (d) shows a process in which the film separated from base paper is stuck on the plating surface of the metal plate with gloss plating. (e) shows a process in which a film is dried; (f) is a process in which a film is stuck by heating onto the plated surface of a metal plate. FIG. 3 is a part of fractured perspective diagram in which the water transfer paper is used for manufacturing of the surface ornament plate.

First, shown in FIG. 2, the manuscript sheet (20) on which the original picture (21) is to be printed is prepared (FIG. 2(a)). In order to manufacture the surface ornament plate (10) efficiently, it is desirable to line up and print two or more original pictures (21) on the manuscript sheet (20).

Next, a picture (21) printed on the manuscript sheet (20) is copied to the water transfer paper (23) by using a color copy machine (22) (see FIG. 2(b)). The water transfer paper (23) is composed of the film (26) which is made of vinyl chloride resin or acrylic resin. This is because, as shown in FIG. 3, the water transfer paper is applied with the water-soluble glue (25) which consists of Carboxymethyl cellulose, polyvinyl alcohol, dextrin, and gum Arabic, onto the backing paper (24). Also it is further applied with vinyl chloride resin or acrylic resin onto the upper part of the film (26). Therefore the film (26) is made of such things as vinyl chloride resin or an acrylic resin. The picture (21) which is printed on the original manuscript sheet is copied onto the film (26) of water transfer film (23). In this case of operation, because of using a copy machine (22) a toner picture (27) having the characteristic of being water-proof is copied onto the surface of the film (26).

Next, the water transfer film (23) of each toner picture (27) is cut to size and makes the piece of paper (28) which is the appropriate size for sticking on the metal plate (11) (FIG. 2(c)). The piece of paper (28) is dropped into the container (30) filled with water (31). By this process, the water-soluble glue is dissolved, and the film (26) is separated from the backing paper (24) (FIG. 2(c)). At that time, in order to separate the film (26) efficiently, it is desirable that the water be heated to between 20 and 30 degree C. (25 degrees C. is the most desirable.)

Next, the film (26) separated from backing paper (24) is stuck on the surface of the metal plate (11) with glossy plating (12). After that, it is pressed on the surface of a film using a rubber spatula (32) or rubber roller or something which is made of elastic material, and the water between the film (26) and the surface of the metal plate (11) is pushed out. In this way the film (26) is fixed firmly on the surface of the metal plate (26) (FIG. 2(d)).

After that, the film (26) which is fixed onto the surface of the metal plate (26) is dried (FIG. 2(e)) at low temperature (room temperature to 70 degrees C.) compared to baking temperature by using a drier (33), etc. Furthermore, the film (26) is fixed onto the surface of the metal plate (26) by baking during 2 to 5 minutes at relatively low temperatures of 80 to 100 degrees (90 degree is the most desirable.) using a gas oven (34), etc.

As mentioned above, it is possible to prevent air bubbles from remaining between the film (26) and the surface of the metal plate (26) because film (26) is dried at low temperature (room temperature to 70 degrees C.) before it is backed and stuck on the plating surface of the metal plate (11) at baking temperature.

Utilizing the process above, it is possible to make a surface ornament plate (10) as shown in FIG. 1.

FIG. 4 shows the other case of the operation of a surface ornament plate using this invention. FIG. 5 shows the manufacturing method of a surface ornament plate shown in FIG. 4. In these diagrams, the same reference marks are used for the same component factors as in the case of the operation above.

Referring to FIG. 4, the surface ornament plate (10) which is one case of the operation of this invention, the film (26) which is separated from the piece of paper (28) from the water transfer film (23) is firmly fixed onto the plating surface of the metal plate (11) with glossy plating (12) using an adhesion-strengthening agent (35) which consists of ethylene glycol mono-butyl ethyl, etc.

When the surface ornament plate (10) is manufactured as shown in FIG. 4, beforehand, the adhesion-strengthening agent (35) is thinly applied onto the plating surface of the metal plate (11) (FIG. 2(c)). After the film (26) separated from the backing paper (24) of the water transfer paper (23) is stuck on the plating surface of the metal plate (11), the water between the film (26) and the surface of the metal plate (11) is pushed out using a rubber spatula (32) etc. When the adhesion-strengthening agent (35) is over-applied, a part of the adhesion-strengthening agent (35) is pushed out with the water from between the film (26) and the plating surface of the metal plate (11). Therefore, it is necessary to push out the adhesion strengthening agent (35) while not allowing it to come in contact with the surface of the film (26)-namely a toner image (27). When the adhesion-strengthening agent (35) is stuck on the rubber spatula (32), it should be wiped off before rubbing on the toner image (27) of the surface of the film (26) in order not to melt the toner image. For this reason it is desirable that the rubber spatula be wiped with a cloth which does not stick to the adhesion-strengthening agent (35) agent.

In the same way as the above-mentioned case of operation, after the film (26) is dried at room temperature to 70 degrees C., the film (26) is baked for 2 to 5 minutes at a relatively low temperature of 80 to 100 degrees C. (90 degrees is the most desirable). Therefore, the film (26) is backed and stuck firmly onto the plating surface of the metal plate (26). At this time, the film (26) could be more firmly stuck on the plating surface of the metal plate (11) because of the melting action caused by the adhesion-strengthening agent (35).

Having described our invention as related to the embodiment shown in the accompanying drawings, it is our intention that the invention be not limited by any of the details of description, unless otherwise specified, but rather be construed broadly within its scope as set out in the accompanying claims. For example, it is possible to select a method of printing, drying, or baking, etc., depending on the size of a surface ornament plate or the manufacturing scale. Also, it is possible to stick a film separated from the backing paper on a plating surface of the metal plate without baking by using adhesives. Further, this invention is widely applicable to not only bookmarks but to tags, nameplates, etc.

As clearly shown in the explanation above, a surface ornament plate excelling in durability and ornamentation and in its method of manufacturing can be provided by utilizing this invention.

What is claimed is:

1. A surface ornament plate bearing a transparent or translucent film printed with a picture stuck on the glossy plating surface of a metal plate.

2. A manufacturing method of a surface ornament plate providing characteristics of:
a process in which certain chosen pictures are printed on the film side of a water transfer paper composed of a transparent or translucent film on a backing paper with water-soluble glue;
a process in which the film is separated from the backing paper of the water transfer paper in a liquid; a process in which the film separated from the backing paper is stuck to the glossy plating surface of a metal plate and fixed to it.

3. A manufacturing method as claimed in claim 2 (above) which is characterized by an applied film adhesion strengthening agent on a plating surface of a metal plate in advance when the film is stuck on the plating surface of the metal plate.

4. A manufacturing method as claimed in claim 2 (above) which is characterized by a baking temperature of 80 to 100 degrees C. as the baking temperature to firmly affix a film on a plating surface of a metal plate.

5. A manufacturing method as claimed in claim 4 (above) which is characterized by drying a film at a lower temperature before that film is baked at a baking temperature.

6. A manufacturing method as claimed in claim 2 (above) which is characterized by printing a film by melting and adhering of a toner image.
